(19) United States
(12) Patent Application Publication
(10) Pub. No.: US 2005/0212252 A1
(43) Pub. Date: Sep. 29, 2005

(54) Single-bolt clipon for motorcycle

(76) Inventor: Michael Czysz, Portland, OR (US)

Correspondence Address: RICHARD C. CALDERWOOD, 2775 NW 126TH AVE, PORTLAND, OR, 97229-8381, US

(21) Appl. No.: 10/812,699

(22) Filed: Mar. 29, 2004

(51) Int. Cl. B62K 17/00

(52) U.S. Cl. 280/279

(57) ABSTRACT

A clipon bracket for coupling a handlebar to a motorcycle fork tube using only a single bolt. A clipon assembly including the clipon bracket, a bar, a bar cap, and a pinch bolt. The clipon bracket includes a fork tube and a bar tube, with the bar tube being external to and substantially perpendicular to the fork tube. A split extends through the bar tube substantially perpendicular to its axis, dividing it into two tubular halves, and extends through one wall of the fork tube. The pinch bolt draws the handlebar and the bar cap into opposite ends of the two tubular halves of the bar tube, pinching the split closed and thereby tightening the fork tube onto the fork leg, using only a single pinch bolt.

### BACKGROUND OF THE INVENTION

1. Technical Field of the Invention

This invention relates generally to motorcycles, and more specifically to a clipon or handlebar mounting bracket which requires only a single bolt.

2. Background Art

Motorcycles are typically built around a frame which includes a steering tube, and include a telescopic fork style “front end”. In such a front end, a pair of telescopic fork legs are coupled to an upper triple clamp and a lower triple clamp, and the triple clamps are coupled to the steering tube by upper and lower bearings and a steering stem. Each telescopic fork leg 11 includes an outer or female tube and an inner or male tube. An upper one of the tubes is coupled to the triple clamps, and a lower one of the tubes is coupled to the front wheel and slides coaxially inside or outside the upper tube, providing suspension between the frame and the front wheel.

Motorcycles are typically provided with one of two types of handlebars.

Dirt bikes, cruisers, and other motorcycles typically have single-piece handlebars which are secured to the upper triple clamp, generally with a pair of brackets which are each bolted down with two bolts.

Sport bikes typically have separate left and right bars referred to as clipons, each coupled to its respective fork leg by a clipon bracket. Each clipon bracket is typically coupled to the fork leg with two and often four bolts, which pinch two halves of the clipon bracket together, tightening it onto the fork leg to prevent it from rotating or moving axially. Additionally, the bar itself is coupled to the bracket with one and often two bolts, in a similar pinching manner.

The more bolts there are, the more machining must be done in manufacturing the bracket, the more time the mechanic must spend putting the machine together, the heavier the assembly is, and the more parts there are to come loose.

What is desirable is a clipon bracket which requires only a single bolt which both couples the bar to the bracket and couples the bracket to the fork leg.

### BRIEF DESCRIPTION OF THE DRAWINGS

FIG. 1 shows a clipon bracket.

FIG. 2 shows a mirror image clipon bracket for the other fork tube.

FIGS. 3 and 4 show the clipon bracket of FIG. 1 from different angles.

FIGS. 5 and 6 show the upper half of a motorcycle front end, using the clipon brackets of FIGS. 1 and 2.

FIG. 7 shows a bar adapted for use with the clipon bracket.

FIG. 8 shows a bar cap for use with the bar and the clipon bracket.

FIG. 9 shows the bar cap in cross-section view.

FIG. 10 shows a clipon assembly in exploded view, with a fork leg.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

FIG. 1 shows a clipon bracket 10 according to one embodiment of this invention. The bracket includes a fork tube 12 for coupling to a fork leg (not shown), and a bar tube 14 for coupling to a handlebar (not shown). The fork tube and the bar tube may be fastened together such as by welding, or they may be of integral, monolithic construction. The inner diameter of the fork tube is sized to fit over the outer diameter of the fork leg. The bracket includes a split 16 which breaks the fork tube into a C shape rather than a complete circle, when viewed axially. The split also divides the bar tube into an inner half 18 and an outer half 20. In some embodiments, the split is oriented substantially perpendicular to the axis of the bar tube. In some embodiments, the split is substantially linear.

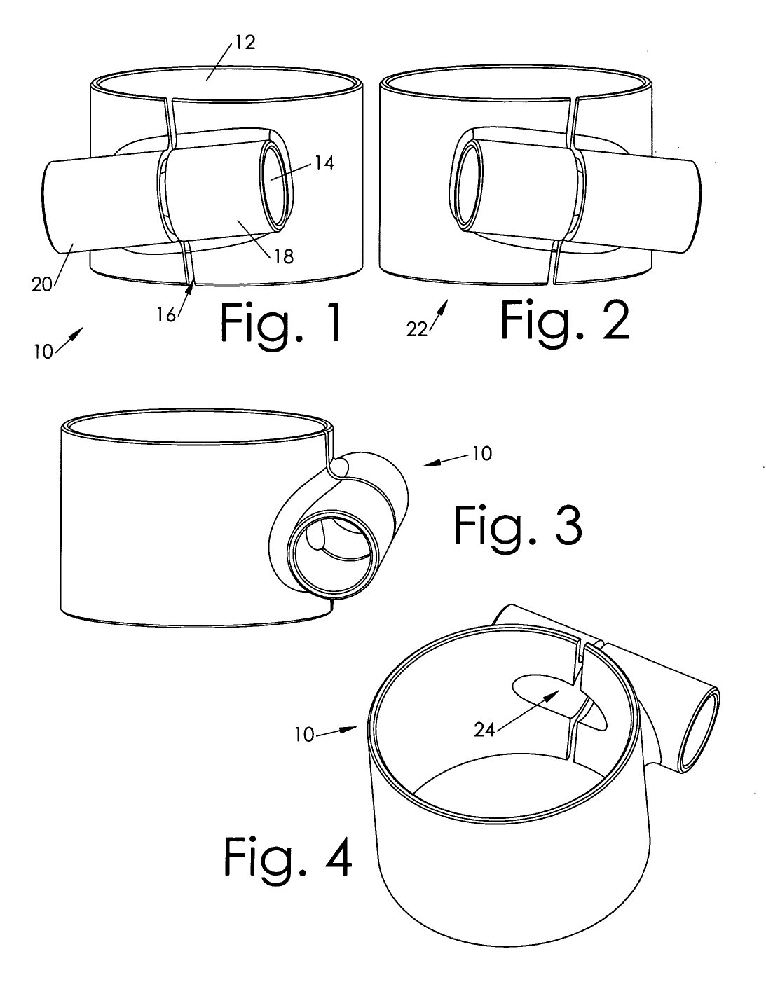

FIG. 2 illustrates a clipon bracket 22 which is a mirror image of that shown in FIG. 1. This is especially useful in embodiments in which the handlebar is angled downward with respect to the fork leg.

FIGS. 3 and 4 illustrate the clipon bracket 10 from two different angles, illustrating an optional be advantageous feature of the invention. The bar tube is not entirely external to the fork tube. In other words, the two tubes intersect, or would if they were complete cylinders. In particular, the inner diameters of the two tubes overlap, exposing a gap region 24, whose use will be explained later.

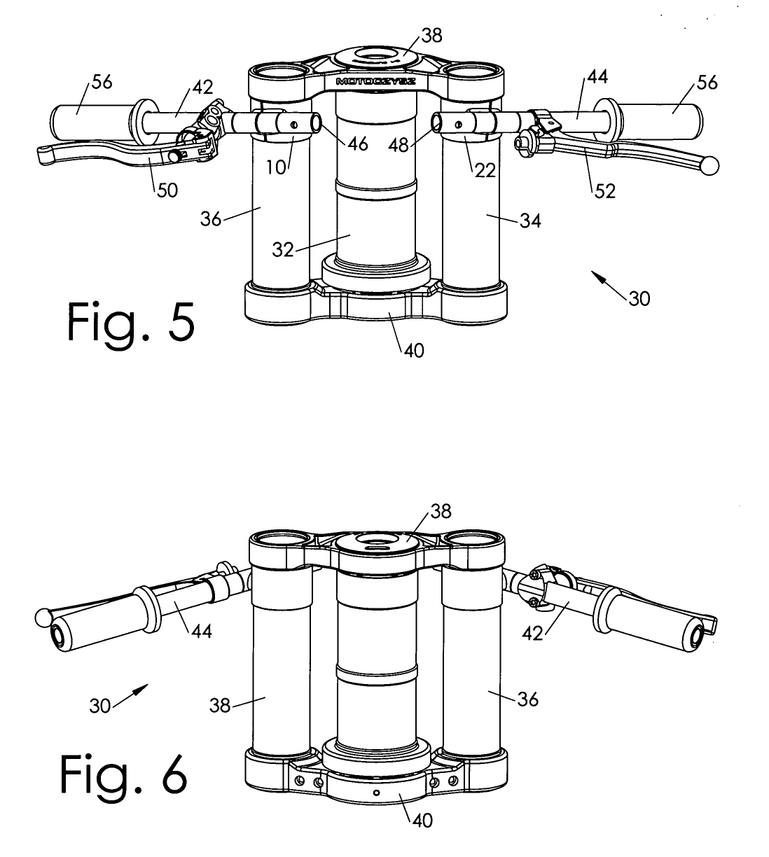

FIGS. 5 and 6 illustrate an upper portion of a motorcycle front end assembly 30 utilizing one embodiment of this invention, as viewed from the front and from the rear (the rider's position), respectively. The front end assembly is rotatably coupled to a steering tube 32 of the motorcycle's frame (not shown). The front end assembly includes a left upper fork leg 34 and a right upper fork leg 36. An upper triple clamp 38 and a lower triple clamp 40 couple the upper fork legs to the steering tube such that the entire assembly can rotate about the axis of the steering tube.

A right clipon bracket 10 couples a right handlebar 42 to the right fork leg, and a left clipon bracket 22 couples a left handlebar 44 to the left fork leg. A right bar cap 46 is coupled to the right clipon bracket, and a left bar cap 48 is coupled to the left clipon bracket.

Typically, a front brake lever assembly 50 is coupled to the right handlebar, and a clutch lever assembly 52 is coupled to the left handlebar, and each handlebar is fitted with a grip 56. A throttle (not shown) is typically fitted to the right handlebar beneath the grip. The throttle and its linkage have been omitted in the interest of clarity.

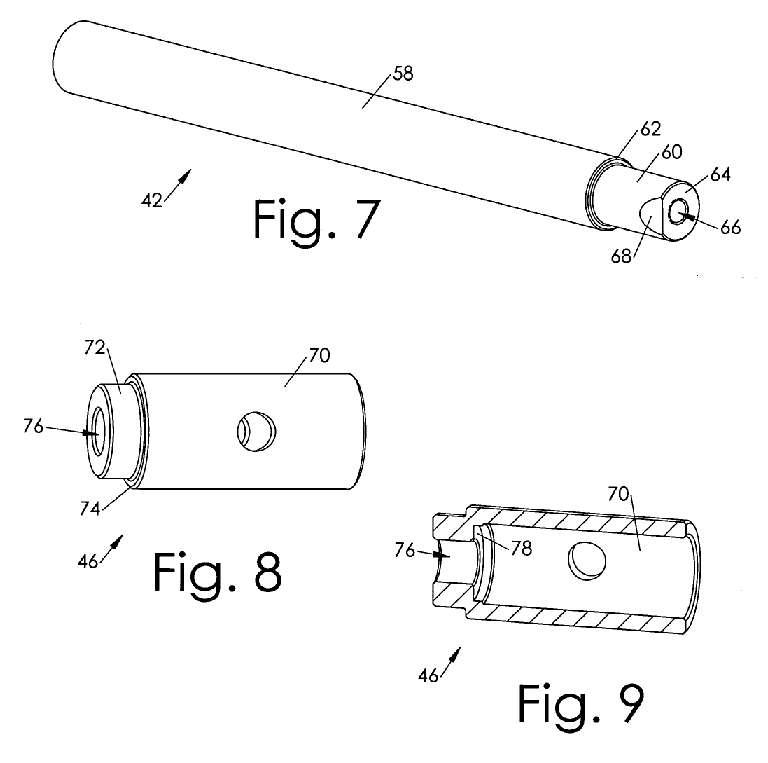

FIG. 7 illustrates one embodiment of a handlebar 42. The handlebar includes a cylindrical shaft 58 having a first diameter, and a smaller diameter shaft extension 60. The shaft extension is sized to fit within the inner diameter of the clipon bracket's bar tube (14 in FIG. 1). The larger diameter of the shaft 42 prevents it from entering the bar tube. Rather, the edge 62 at the diameter change will bottom against the bar tube.

The shaft extension includes an end 64 having a threaded axial hole 66. (In the interest of clarity, threads are omitted from the drawings.)

The shaft extension optionally includes an indented portion 68 which is used in conjunction with embodiments in which the clipon bracket includes a gap region (24 in FIG. 4), and serves to key the bar into a predetermined rotational angle with respect to the fork leg (not shown).

FIG. 8 illustrates one embodiment of a bar cap 46, and FIG. 9 illustrates it in cutaway view. The bar cap includes a hollow shaft 70 and a smaller diameter shaft extension 72. The shaft extension fits within the clipon bracket's bar tube, but the shaft does not, so the edge 74 of the bar cap bottoms against the bar tube. The shaft extension includes an axial hole 76. Inside the hollow shaft, the shaft extension includes a face 78.

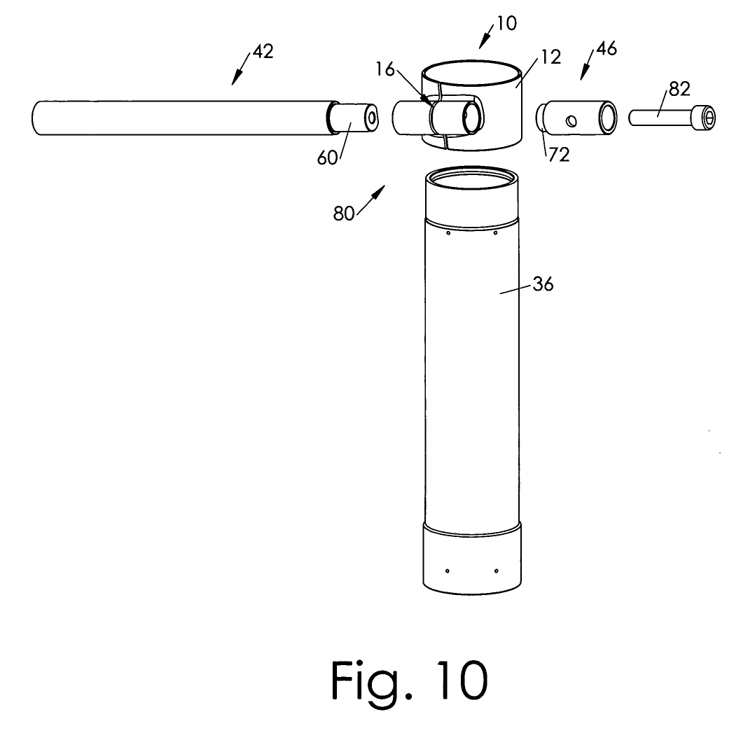

FIG. 10 illustrates one embodiment of a right clipon assembly 80, in exploded view. The fork tube 12 of the clipon bracket 10 is slid onto the fork leg 36. The shaft extension 60 of the bar 42 is inserted into the outer half 20 of the bar tube 14 of the clipon bracket, and the shaft extension 72 of the bar cap 46 is inserted into the inner half 18 of the bar tube. A threaded pinch bolt 82 is inserted into the open end of the bar cap, through the bar cap shaft extension, and threaded into the bar shaft extension until the head of the bolt bottoms against the face 78 of the bar cap, and the bar cap and the bar bottom against opposite ends of the bar tube. Then, as the pinch bolt is tightened further, the split 16 narrows, permitting the fork tube to tighten onto the fork leg. Thus, the bar is coupled firmly to the clipon bracket, and the clipon bracket is coupled firmly to the fork leg, with a single pinch bolt.

Optionally, the single pinch bolt can be securely held in place, such as with the use of a lock washer or Loc-Tite.

In some embodiments, the bar cap may be integrally formed with the clipon bracket. In still other embodiments, the bar cap as such may be omitted, and its half of the bar tube may be dimensioned such that the pinch bolt will bottom against it, and the bar shaft extension will have sufficient clearance to permit the fork tube to be pinched onto the fork leg.

In some embodiments, the bar shaft extension (or bar cap shaft extension) may be the same diameter as the bar shaft, or even larger, and another means is provided for bottoming against the bar tube of the clipon bracket, such as a ridge. In some embodiments, the bar shaft and/or bar shaft extension (or bar cap shaft and/or bar cap shaft extension) may have a non-cylindrical shape, such as octagonal. In some embodiments, the bar shaft extension and/or bar cap shaft extension may include a means for clocking to a particular rotational angle with respect to the clipon bracket, such as a keyway or a flat or other asymmetry. In some embodiments, the clipon bracket may be clocked to the fork leg.

### CONCLUSION

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. The invention is not limited to the details described above. Rather, it is the following claims including any amendments thereto that define the scope of the invention.

1. A clipon bracket comprising:
a fork tube;
a bar tube coupled to the fork tube;
a split dividing the fork tube into a C shape and dividing the bar tube into two tubular portions.

2. The clipon bracket of claim 1 wherein:
an inner diameter of the fork tube and an inner diameter of the bar tube overlap, such that an inner surface of the fork tube includes a gap region.

3. The clipon bracket of claim 1 wherein:
an axis of the bar tube is 5 to 25 degrees off perpendicular to an axis of the fork tube.

4. A motorcycle clipon assembly for coupling to a motorcycle fork leg, the clipon assembly comprising:
(A) a clipon bracket including,
a fork tube having an inner diameter suitable for mating with an outer diameter of the fork leg,
a bar tube, and
a split dividing the fork tube into a C shape and dividing the bar tube into first and second tubular portions;
(B) a handlebar including,
a shaft, and
shaft extension inserted into the bar tube and including a threaded axial hole;
(C) a bar cap including,
a shaft, and
a shaft extension inserted into the bar tube and including an axial hole; and
(D) a threaded pinch bolt inserted through the bar cap shaft hole and engaged with the threaded axial hole in the shaft extension of the handlebar.

5. The clipon assembly of claim 4 wherein:
the clipon bracket is configured such that the handlebar is at an angle between 5 and 25 degrees off perpendicular to an axis of the fork leg.

6. A motorcycle front end for rotatably coupling to a steering tube of a motorcycle frame, the front end comprising:
left and right fork legs;
upper and lower triple clamps coupled to the fork legs and rotatably couplable to the steering tube;
left and right clipon handlebars coupled to the left and right fork legs, respectively;
wherein at least one of the handlebars is coupled to its respective fork leg by a clipon assembly including,
a clipon bracket which comprises first and second generally perpendicular and generally tangentially mated cylinders having a split generally axial to the first cylinder and substantially perpendicular to the second cylinder, wherein the at least one of the handlebars extends into a first end of the second cylinder,
a bar cap extending into a second end of the second cylinder, and
a pinch bolt engaging the bar cap and the handlebar to bottom them against their respective ends of the second cylinder and thereby pinch the first cylinder onto the respective fork leg.

7. The front end of claim 6 wherein:
both of the handlebars are coupled to their respective fork legs by such clipon assemblies.

8. A motorcycle handlebar assembly for coupling to a motorcycle fork leg and comprising:
a clipon bracket including,
a fork tube,
a bar tube coupled to and substantially external to the fork tube so as to be generally perpendicular to the fork tube, and
a split extending generally axially through the fork tube and generally perpendicularly through the bar tube; and
a handlebar having a substantially axial threaded hole at one end, the one end extending into the bar tube;
a threaded pinch bolt including a head engaged with the bar tube, and a threaded shaft extending axially through the bar tube and engaged with the threaded hole of the handlebar, whereby when the pinch bolt is tightened, the head and the handlebar tighten are drawn against the bar tube and the split is pinched closed, whereby the fork tube is tightened against the fork leg.

9. The motorcycle handlebar assembly of claim 8 further comprising:
a bar cap extending into the bar tube and being disposed between the bar tube and the pinch bolt.
